(19) United States
(12) Patent Application Publication
(10) Pub. No.: US 2018/0208201 A1
(43) Pub. Date: Jul. 26, 2018

(54) SYSTEM AND METHOD FOR A FULL LANE CHANGE AID SYSTEM WITH AUGMENTED REALITY TECHNOLOGY

(71) Applicant: Deutsche Telekom AG, Bonn (DE)

(72) Inventors: Pan Hui, Hong Kong (CN); Da Yang, Hong Kong (CN); Wenxiao Zhang, Hong Kong (CN); Christoph Peylo, Damme (DE)

(21) Appl. No.: 15/744,890

(22) PCT Filed: Mar. 23, 2016
(86) PCT No.: PCT/EP2016/056334

§ 371 Date: Jan. 15, 2018

(51) Int. Cl. B60W 30/18; B60W 50/14; B60R 1/00; G06K 9/00; H04N 7/18; H04N 5/247

(52) U.S. Cl. CPC B60W 30/18163; B60W 50/14; B60R 1/00; G06K 9/00798; G06K 9/00805; B60R 2300/105; H04N 5/247; B60W 2050/146; B60W 2420/42; B60W 2550/30; H04N 7/181

(57) ABSTRACT

A method of assisting a full lane change process using at least five cameras provided on a vehicle, a computational device, and an augmented reality device includes: capturing images with the at least five cameras; generating lane change information from the captured images; and displaying the lane change information with the augmented reality device. Generating the lane change information further includes: detecting lanes; detecting the positions and velocities of other vehicles surrounding the vehicle; and generating at least one lane change recommendation.

### CROSS-REFERENCE TO RELATED APPLICATIONS

This application is a U.S. National Phase application under 35 U.S.C. § 371 of International Application No. PCT/EP2016/056334, filed on Mar. 23, 2016. The International Application was published in English on Sep. 28, 2017 as WO 2017/162278 A1 under PCT Article 21(2).

### FIELD

The present invention relates to a lane change aid system, more particularly to a lane change aid system, using augmented reality to display lane change guidance information. Moreover, lane change algorithms are used, including a lane change decision algorithm, a lane change preparation algorithm, and a lane change execution algorithm.

### BACKGROUND

The lane change maneuver is complex, and an inappropriate lane change maneuver easily results in a crash. Lane change crashes, or more specifically the lane change family of crashes, are defined as two-vehicle crashes that occur when one vehicle encroaches into the path of another vehicle initially on a parallel path with the first vehicle and traveling in the same direction

The lane change decision is a process of choosing a target lane and a target gap. The lane change preparation is the process that a lane change driver prepares for further lane change execution by adjusting their speeds and gaps to surrounding vehicles. The lane change execution is the final stage of the lane change, in which the vehicle finishes the final lateral movement from the current lane to the target lane.

Several lane change aid systems are known to the skilled person, e.g., radar-based lane change warning systems. The radar-based lane-change warning systems warn vehicle drivers about other vehicles in their blind spots when they are making lane-changing decisions. However, the existing lane change aid systems have some shortcomings.

First, existing lane change aid systems merely provide information of the states of the vehicles on the target lane, e.g., the position, speed. They are not aiding the lane change execution, since finishing the lane change process still depends on drivers' own judgment. The existing systems do not provide any suggestions to help the driver to execute the lane change process safely and quickly.

Second, the state of the art lane change aid systems easily cause distractions to the driver. The existing lane change aid systems require the driver to put attention on the system to read the information, which brings a considerable risk to the driver.

### SUMMARY

In an exemplary embodiment, the present invention provides a method of assisting a full lane change process using at least five cameras provided on a vehicle, a computational device, and an augmented reality device. The method includes: capturing images with the at least five cameras; generating lane change information from the captured images; and displaying the lane change information with the augmented reality device. Generating the lane change information further includes: detecting lanes; detecting the positions and velocities of other vehicles surrounding the vehicle; and generating at least one lane change recommendation.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic diagram of an embodiment of the invention;

FIG. 2 shows the area covered by the at least five cameras in an embodiment of the invention;

FIG. 3 shows a flow diagram for the processing in the traffic state acquisition unit in one embodiment of the invention;

FIG. 4 shows the flow diagram for the processing in the vehicle detection unit in one embodiment of the invention;

FIG. 5 illustrates the calibration of a camera according to one embodiment of the invention;

FIG. 6 shows the work flow of the lane change recommendation unit in one embodiment of the invention; and

FIG. 7 shows the lane change guidance information as it may be displayed on an augmented reality device interface in one embodiment of the invention.

### DETAILED DESCRIPTION

In one aspect of the invention a method of assisting a full lane change process with the help of an augmented reality device is provided. The method uses at least five cameras provided on a vehicle, a computational device, and an augmented reality device. The method comprises the steps of capturing images with the at least five cameras, generating lane change information from the captured images, and displaying the information with the augmented reality device. The step of generating lane change information comprises the further steps of detecting lanes, detecting the position and velocities of other vehicles surrounding the vehicle, and generating at least one lane change recommendation in a lane change recommendation unit.

In another aspect of the invention at least a first camera is imaging an area in the driving direction of the vehicle, and at least a second and third camera and a fourth and fifth camera are imaging an area on a left and a right side of the vehicle, respectively.

In another aspect of the invention the first camera is capturing images from a position close to or at the front of the vehicle and/or the second and third camera and a fourth and fifth camera are capturing images from a position close to or at the left and right side mirror of the vehicle, respectively.

In another aspect of the invention the step of detecting lanes comprises, locating areas of interest in the captured images according to the grey level of different areas, and detecting the edges of the road and/or the lane lines, preferably by using a Sobel method.

In another aspect of the invention the detecting of vehicles includes locating areas of interest in the captured images according to the grey level of different areas, and extracting the boundary of at least one vehicle, preferably by a Haar-like feature detector, preferably using an AdaBoost algorithm.

In another aspect of the invention the number of false positives is reduced by using two different techniques, preferably a size filter technique and an aspect ratio filter technique.

In another aspect of the invention generating the positions and velocities of the surrounding vehicles includes the step of transforming a coordinate system from one perspective to another using Inverse Perspective Mapping technology, and using the time difference between two subsequent frames to calculate a relative velocity between the other vehicles and/or the vehicle.

In another aspect of the invention displaying the information comprises at least one further step of converting the at least one lane change recommendation into a graphical information and displaying the graphical information on an augmented reality device, preferably with other information relevant to the driver.

In another aspect of the invention the generating of at least one lane change recommendations includes making a lane change decision and/or to select a target lane and/or a target gap; providing information whether the target gap and target speed are ready or not; providing information on adjusting gaps between the vehicle and the surrounding vehicles; providing information on synchronizing the speed of the vehicle to the target lane speed; and/or providing information on the a lane change execution.

In another aspect of the invention prior to using the cameras as calibrated, the calibration step comprises finding the camera focal length using the chessboard calibration; and/or calibrating the cameras to estimate the real world length of a pixel.

In another aspect of the invention a system for assisting a full lane change process with the help of an augmented reality device is provided. The System comprises at least five cameras provided on a vehicle and configured to capture images. The system further comprises a computational device configured to generate lane change information from captured images. The system still further comprises an augmented reality device configured to display the lane change information. Furthermore, to generate lane change information the system is further configured to detect lanes and to detect the position and velocities of other vehicles surrounding the vehicle and further configured to generate at least one lane change recommendation in a lane change recommendation unit.

In another aspect of the invention at least a first camera is adopted to image an area in the driving direction of the vehicle, and at least a second and third camera and a fourth and fifth camera are adopted to image an area on a left and a right side of the vehicle, respectively.

In another aspect of the invention the first camera is positioned close to or at the front of the vehicle and the second and third camera and a fourth and fifth camera are positioned close to or at the left and right side mirror of the vehicle, respectively.

In another aspect of the invention in order to detect lanes the system is further configured to locate areas of interest in the captured images according to the grey level of different areas, and to detect the edges of the road and/or the lane lines, preferably by using a Sobel method.

In another aspect of the invention in order to detect vehicles the system is further configured to locate areas of interest in the captured images according to the grey level of different areas, and to extract the boundary of at least one vehicle, preferably by a Haar-like feature detector, preferably using an AdaBoost algorithm.

In another aspect of the invention the system is configured to reduce the number of false positives by using two different techniques, preferably a size filter technique and an aspect ratio filter technique.

In another aspect of the invention the system is configured to use Inverse Perspective Mapping technology to generate the positions and velocities of the surrounding vehicles by transforming a coordinate system from one perspective to another, and to use the time difference between two subsequent frames to calculate a relative velocity between the other vehicles and the vehicle.

In another aspect of the invention the system is configured to convert the at least one lane change recommendation into a graphical information and to display the graphical information on the augmented reality device, preferably with other information relevant to the driver.

In another aspect of the invention a system for assisting a full lane change process with the help of an augmented reality device is provided. The system comprises a traffic state acquisition unit configured to generate a position and speed information for vehicles of interest, including a lane change vehicle, a preceding vehicle on a current lane, a preceding vehicle and a lag vehicle on a left lane, and a preceding vehicle and a lag vehicle on a right lane. The system further comprises a lane change recommendation unit configured to provide a lane change recommendation for the driver according to a full lane change model including lane change decision model, a lane change preparation model, and a lane change execution model. The system still further comprises a lane change recommendation display unit configured to convert the lane change recommendation into a graphic information and display it on an augmented reality device.

In another aspect of the invention a vehicle with a system for assisting a full lane change process with the help of an augmented reality device is provided. The system is configured to perform the method according to any preceding aspects of the invention.

In one embodiment of the invention a lane change aid system with the help of augmented reality technology is provided. By using the graphic processing technique instead of radar, the system is able to detect the vehicle position and velocity in real time. Using lane-changing models and vehicle detection technology, the system provides the driver with augmented information on an augmented reality device, such as displaying a symbol or a maneuver recommendation on an augmented reality device. The system allows for a safe lane change and reduces the risk of lane change execution collision to a minimum level. Compared to the state of the art lane change aid systems, the system according to the invention offers two improvements.

First, the system not only provides a danger warning for the driver, but also provides recommendations to help the driver to make a lane change decision, prepare for the lane change maneuver, and guides the driver through the execution of the lane change maneuver.

Second, the system reduces the distractions caused to the driver by the lane change aid system by adopting the augmented reality technology. Using an augmented reality device, the driver does not need to turn the head to watch a mirror; instead the driver may only need to follow the guidance displayed on the augmented reality device. In one embodiment of the invention the apparatus and/or the system, according to an aspect of the invention, includes cameras installed on both sides of the lane change vehicle for capturing the vehicle and lane images and a control that is responsive to an output of said imaging device to recognize the position of the vehicles and which lane the vehicle is on. The control is operable to distinguish between certain types of vehicles. The control may provide the distance, relative velocity, acceleration, and time gap of the included vehicles for further processing.

In one embodiment of the invention the apparatus and/or the system, according to an aspect of the invention, includes a forward-facing imaging device for capturing images of the preceding vehicles both on the current and adjacent lanes and a control that is responsive to an output of said imaging device to calculate the distance and velocity of the preceding vehicle of the lane change vehicle. The control may also provide the distance, relative velocity, acceleration, and time gap of the preceding vehicle for further processing.

In one embodiment of the invention the apparatus and/or the system, according to an aspect of the invention, includes a computing device configured for processing the information collected from the outside and producing a lane change guidance and a control that is responsive to an output of said imaging device to calculate the distance and velocity of the vehicles. The computing device may include a lane change aid algorithm to make decisions and recommendation for the driver. The control may include a wireless transmission channel to transmit the lane change recommendations to the augmented reality device.

Hereinafter, exemplary embodiments of the present invention will be described in detail with reference to the accompanying drawings. The same reference numerals used throughout the specification refer to the same constituent elements. The skilled person will recognize that some of the features of the subject-matter can be implemented in different devices device. In particular, different steps of the method can be performed in different physical devices. For example, the image processing can be performed in part in a camera, in a computing device, and/or in an augmented reality device.

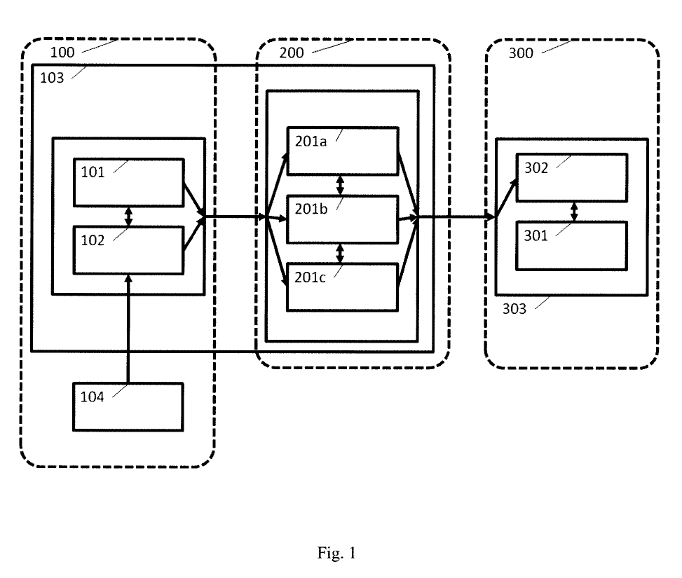

FIG. 1 shows a schematic diagram of an embodiment of the invention. The embodiment comprises three functional units. A traffic state acquisition unit 100, a lane change recommendation unit 200, and a lane change recommendation display unit 300.

The traffic state acquisition unit 100 comprises the cameras 104, a lane detection unit 102, and a vehicle detection unit 101. The computational part of the traffic state acquisition unit 100 may be implemented in a computing device 103. The traffic state acquisition unit is operationally connected to a lane change recommendation unit 200. The cameras 104 are operationally connected to the computing device 103.

The lane change recommendation unit 200 comprises a full lane change model 201 including a lane change decision model 201a, a lane change preparation model 201b, and a lane change execution model 201c. The computational part of the lane change recommendation unit 200 may be implemented in the computing device 103. The lane change recommendation unit 200 is operationally connected to the traffic state acquisition unit 100 and the lane change recommendation display unit 300.

The lane change recommendation display unit 300 comprises an augmented reality image processing unit 302 and an augmented reality display unit 301. The computational part of the lane change recommendation display unit 300 is preferably implemented in the computing device 103 and/or the augmented reality display unit 301 itself. The augmented reality image processing unit 302 and the augmented reality display unit 301 are preferably implemented in the augmented reality device 303.

In one embodiment of the invention the computing device 103 is used to process the images and extract the needed information. In an exemplary embodiment OpenCV 2.4 may be used to handle the computer vision.

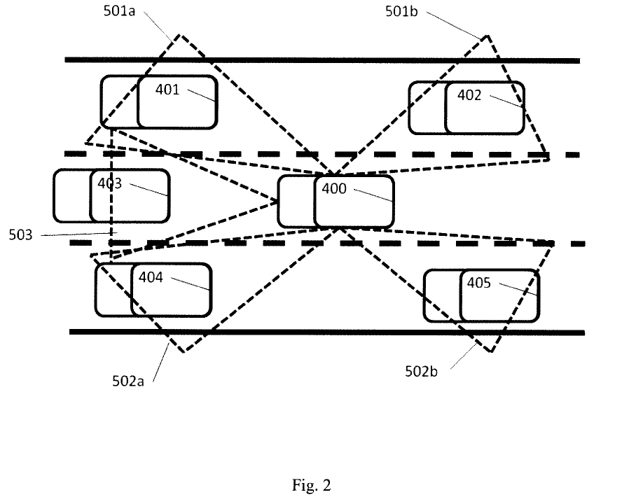

In one embodiment of the invention within the traffic state acquisition unit 100, the cameras 104 capture images of an area (c.f. FIG. 2) including the current lane, where the lane change vehicle 400 is, and a left lane and a right lane with respect to the current lane. The images are then transmitted as input images to the computing unit 103. Still within the traffic state acquisition unit 100 the lane detection unit 102 identifies road lanes and the vehicle detection unit 101 recognizes vehicles on the current and adjacent lanes.

In one embodiment of the invention, the traffic state acquisition unit 100 transmits the distances and velocities of the surrounding vehicles of the lane change vehicle 400 to the lane change model 201 in the lane change recommendation unit 200. The lane change recommendation unit 200 generates a lane change recommendation and transmits lane change recommendation to the lane change recommendation display unit 300.

In one embodiment of the invention within the lane change recommendation display unit 300, the received lane change recommendation is processed in the augmented reality image processing unit 302 and displayed in the augmented reality display unit 301.

FIG. 2 shows the area covered by the at least five cameras 104a, 104b, 104c, 104d, 104e in one embodiment of the invention of the invention. The five cameras 104a, 104b, 104c, 104d, 104e are positioned on the left side mirror, right side mirror and front face of the vehicle, respectively. The front camera 104c captures images of an area 503 in front of the vehicle (400), i.e., the preceding vehicles 403 on the current lane may be captured by the first camera 104c. The left side cameras 104a and 104b capture a forward area 502a and a backward area 502b on the left side of the vehicle 400, i.e., they capture the left preceding vehicle 404 and left lag vehicle 405 on the left adjacent lanes. The right side cameras 104d and 104e capture a forward area 501a and a backward area 501b on the right side of the vehicle 400, i.e., they capture the right preceding vehicle 404 and right lag vehicle 405 on the right adjacent lanes. For illustration purpose in this embodiment five vehicles need to be monitored, the vehicles 401, 402, 403, 404, and 405. These five vehicles 401, 402, 403, 404, and 405 have an effect on the lane change behavior and are included in the lane change model unit 201. If one of the five vehicles is not present in the area of interest 501, 502, 503, it will not be considered in the lane change model unit 201. Furthermore, the lane change vehicle 400 is shown in FIG. 2.

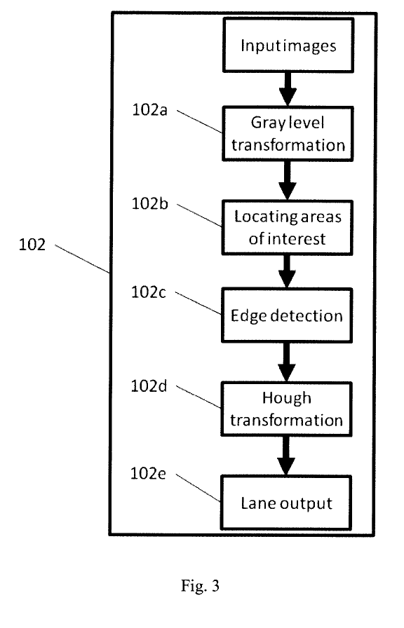

FIG. 3 shows a flow diagram for the processing in the traffic state acquisition unit 100 in one embodiment of the invention. The processing is preferably performed in the lane detection unit 102. The captured pictures are processed to locate and extract the lane lines. In the current embodiment the captured input images are RGB color images that may consume a lot of processing time, in a first step they are transformed to gray images in part 102a.

Then part 102b is used to locate the area of interest, i.e., the road area. Since different areas have different gray levels and compared to other areas, the road area has a lower gray level, part 102b may use the gray levels to extract the road area.

Part 102c further extracts the edges of the roads, which are the lane lines. The method used in part 102c to extract lane lines may be the Sobel method. However, after employing part 102c, although lane lines are extracted from the original images, a lot of noise may still exist.

In a next step part 102d is employed. Part 102d is adopted to reduce noise and finally obtain the road edges and lanes. 102d is preferably an Hough transform method. Finally, the lanes are detected and output by part 102e.

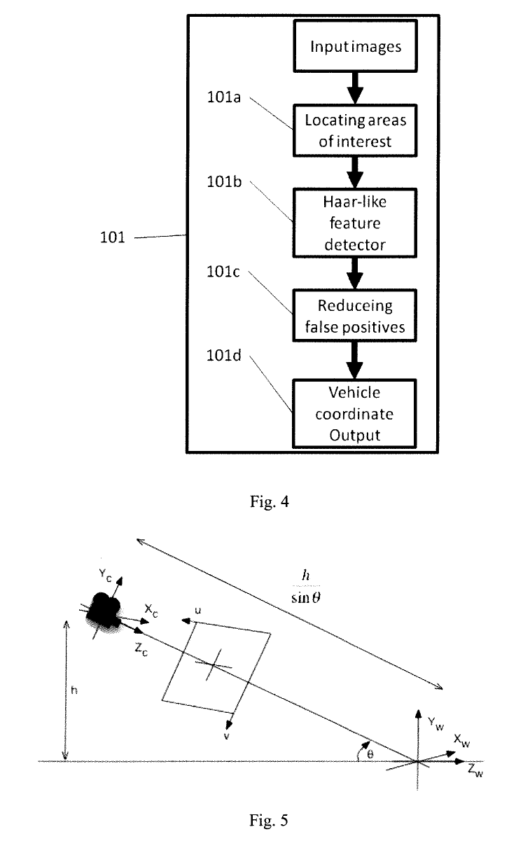

FIG. 4 shows the flow diagram for the processing in the vehicle detection unit 101 in one embodiment of the invention. In one embodiment of the invention, a Haar-like feature detector algorithm is adopted to detect the vehicles 401, 402, 403, 404, and 405 from the captured input images. The vehicle detection unit 101 performs the preprocessing for every image (frame) captured from the cameras in order to improve the overall efficiency and accuracy.

In one embodiment of the invention in part 101a the area of interest is located. Although the input image preferably has been resized, the size of input images may still be too large for the feature detection algorithm. Locating the areas of interest of the input images is utilized in order to make the vehicle detection unit 101 to respond in real-time. Preferably, the center of the resized grey input images is chosen as the area of interest for detecting vehicles.

In one embodiment of the invention a calibration of the position of the respective camera 104 is utilized so that the target vehicles 401, 402, 403, 404, and 405 may always appear in the center of the respective input images.

In one embodiment of the invention in part 101b preferably a Haar-like feature detection algorithm is used for vehicle detection. The Haar-like feature detector in part 101b preferably uses an AdaBoost algorithm because of its fast speed and high accuracy, as it is commonly used in face detection. The Haar-like feature detector in part 101b may need to be retrained to be used in detection of vehicles. Preferably a tool to perform basic operation of training data is used for the retraining of the Haar-like feature detector in part 101b. For example, imglab is preferably used.

A false positive is a result that the Haar-like feature detector in part 101b points out as an object to be a vehicle, but the object not being a vehicle. False positives will greatly reduce accuracy of the traffic state acquisition unit 100.

In one embodiment of the invention part 101c is used to reduce the number of false positives. In one embodiment of the invention two different techniques are adopted in part 101c, namely, a size filter and an aspect ratio filter. The size filter will filter out the detected vehicle if the height of it is too large or too small. The aspect ratio filter makes use of the general aspect ratio of a vehicle. Most vehicles have an aspect ratio, i.e., the width-to-height ratio, ranging from 0.4 to 1.6. If the aspect ratio of a detected vehicle is out of said range, it is probably a false positive and part 101s preferably abandons the result.

In one embodiment of the invention part 101d provides the bottom coordinate of a verified vehicle to the Inverse Perspective Mapping (IPM) subsystem 600 for further determining the vehicles distance and relative velocity.

FIG. 5 illustrates the calibration of a camera according to one embodiment of the invention. To use the IPM subsystem 600, the cameras 104 have to be calibrated. The height h of a camera 104, the angle θ from the camera to the ground and the focal length K of the camera 104 are utilized to map pixel on the image plane to a top down view. The measures h and l are obtained by adjusting the position and orientation of the camera, while the camera focal length K needs to be estimated by calibrating the camera. The camera focal length K is found using the chessboard calibration which is well known to the skilled person. Preferably the chessboard calibration, as it is included in the OpenCV [1] library, may be used to calculate the focal length K of a camera. The information about the height h of the camera, the angle θ from the camera to the ground and the focal length K of the camera are obtained and stored in the calibration process.

After the calibration process for the IPM has been performed once, the IPM transformation can be performed. Pixels P between two objects in the transformed image will represent their distance.

To relate the pixels to a real world distance, the distance calibration is performed as well prior to the first use of one embodiment of the invention. For the distance calibration the camera 104 may be mounted on a fixed known height h and angle θ, then a string with length I will be placed in front of the camera. After the camera 104 takes a picture of the string, the image will be fed to the IPM algorithm along with the focal length K of the camera 104. The numbers of pixels p occupied by the length l string in the transformed image will represent length l in real world. By dividing l by p, the length one pixel represent in real world can be estimated.

The above described calibration method is not meant to limit the scope if the invention. In general any calibration method may be used for calibrating the cameras 104 that allows relating the pixel number obtained by the IPM to a real world distance. Moreover, once the calibration has been performed the calibration parameters can be stored and/or used for any identical and/or similar camera positioned in a same/similar height and angle.

In one embodiment of the invention a calibrated traffic state acquisition unit 100 provides the distance and relative between the lane change vehicle 400 and any target vehicle 401, 402, 403, 404, and 405. The relative velocity for any target vehicle 401, 402, 403, 404, and 405 can be calculated by dividing the distance difference d and time difference t between two frames. For the processing in the lane change recommendation unit 200 the relative speed is utilized instead of an absolute speed.

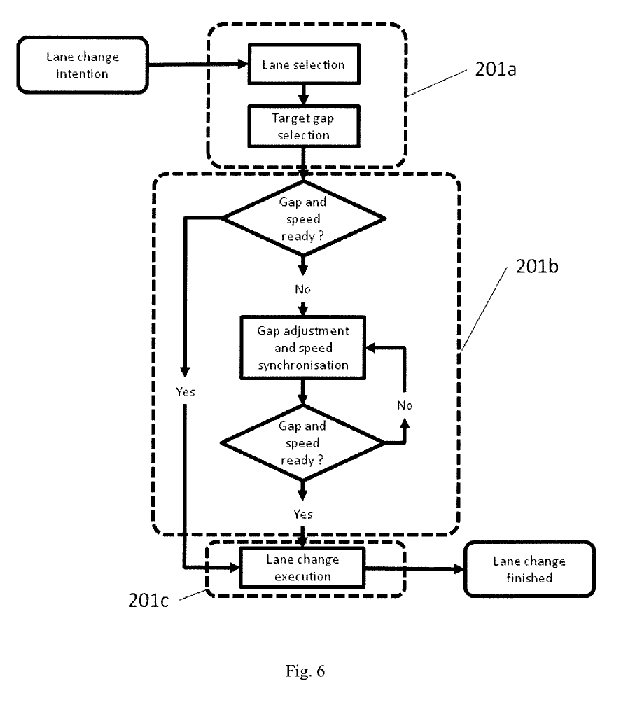

FIG. 6 shows the work flow of the lane change recommendation unit 200 in one embodiment of the invention. The obtained vehicle information from the traffic state acquisition unit 100 is used to produce a lane change recommendation within the lane change model unit 201. The lane change model unit 201 comprises three parts: the lane change decision unit 201a, the lane change preparation unit 201b, and the lane change execution unit 201c.

In a first step the lane change decision unit 201a, upon the driver inputting a lane change intention, makes a decision to determine which lane to change in. Then a target gap is selected in the selected lane. Alternatively or in addition the driver may input a target lane and a target gap.

In a next step the lane change preparation unit 201b determines whether or not the target gap and speed are suitable to further conduct a lane change execution. If yes, the driver can continue to execute the lane change; if not, the driver has to further adjust the gaps to other vehicles 401, 402, 403, 404, and 405 or synchronize the speed to the surrounding vehicles 401, 402, 403, 404, and 405 on the target lane.

In a final step the lane change execution unit 201c is employed while the driver executes the lane change.

Depending on the respective situation the corresponding lane change recommendation is sent to the lane change recommendation display unit 300 to be displayed in the augmented reality display unit 302. The lane change model unit 201 preferably uses a lane decision model such as the one described in Gipps [2].

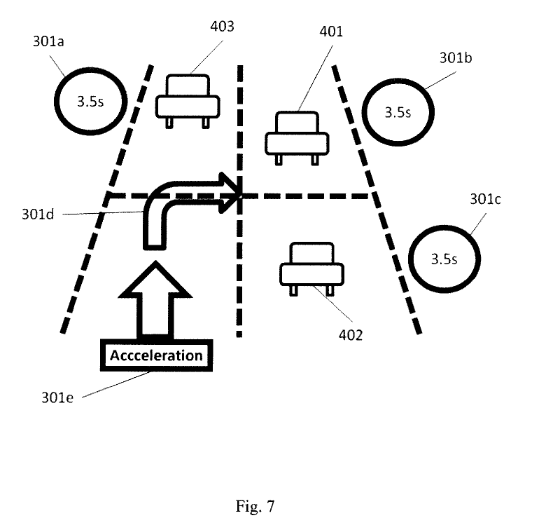

FIG. 7 shows the lane change guidance information as it may be displayed on an augmented reality device interface in one embodiment of the invention. The lane change recommendation is received by the lane change recommendation display unit 300 is processed in the augmented reality image processing unit 302. The reality image processing unit 302 generates graphical information to be displayed on the augmented reality display unit 301.

In one embodiment of the invention the surrounding vehicles are displayed, i.e., the preceding vehicle 403 on the current lane, the preceding vehicle 401 on the target lane, and the lag vehicle 402 on the target lane. The time gaps 301a, 301b, and 301c for the respective one of the three vehicles are displayed. Furthermore, an arrow 301d is displayed to point out the appropriate lane change point. Alternatively or in addition an instruction field 301e, e.g., “acceleration” or “deceleration”, is displayed to the driver.

In one embodiment the augmented reality display unit displays the graphical lane change guidance information as a graphical overlay in the field of view of the driver. Furthermore, the interaction between the driver and the system and/or method, such as expressing the lane change intention, is performed with a hands free human interface device, e.g., a voice control input or a facial recognition input.

In one embodiment of the invention the system, apparatus and/or method automatically and/or continuously provides the driver with lane change information.

In one embodiment of the invention the system, apparatus and/or method is implemented in the vehicles 400 electronic system and is preferably using build-in hardware components, e.g., and on board computing device and/or on board cameras and/or augmented reality device.

In one embodiment of the invention the system, apparatus and/or method is implemented in the vehicles 400 electronic system and is preferably using build in hardware devices, e.g., and on board computing device and/or on board cameras. However, in this embodiment the system, apparatus and/or method uses and separate augmented reality device.

In one embodiment of the invention the system, apparatus and/or method is implemented in separated hardware devices but connects to the vehicle 400 and uses an augmented reality device build into the vehicle.

In one embodiment of the invention the system, apparatus and/or method is implemented in separated hardware devices and uses a separate augmented reality device.

In one embodiment of the invention the different parts of the invention are operationally interconnected with each other using suitable connecting components. The connecting components may correspond to a physical connection, e.g., a cable, and/or a wireless connection, e.g., Wi-Fi or Bluetooth.

In one embodiment of the invention the augmented reality device is preferably a wearable electronic device, e.g. smart glasses.

Although the embodiments of the invention have been illustrated and described as above, of course, it will be apparent to those skilled in the art that the embodiments are provided to assist understanding of the present invention and the present invention is not limited to the above described particular embodiments, and various modifications and variations can be made in the present invention without departing from the scope of the present invention, and the modifications and variations should not be understood individually from the viewpoint or scope of the present invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCES

[1] Opencv.org, ‘Camera Calibration with OpenCV’, 2015. [Online]. Available: http://docs.opencv.org/2.4/doc/tutorials/calib3d/camera_calibration/camera_calibration.html.
[2] Gipps P G. A model for the structure of lane-changing decisions. Transportation Research Part B: Methodological, 1986, 20(5): 403-414.
[3] Sen, Basav, John D. Smith, and Wassim G. Najm. Analysis of lane change crashes. DOT-VNTSC-NHTSA-02-03/DOT HS 809 571, 2003.
[4] L. Trego, “Lane-change Warning System,” SAE International, 10 Oct. 2008; [Online]. Available: articles.sae.org/4545/.
[5] DasAuto, “Side Assist,” 2015; http://en.volkswagen.com/en/innovation-and-technology/technical-glossary/spurwechselassi stentsideassi st.html.
[6] Opencv.org, ‘OpenCV|OpenCV’, 2015. [Online]. Available: http://opencv.org/.
[7] R. C. Gonzalez, R. E. Woods, Digital Image Processing, Addison-Wesley, New York, 1992.
[8] Illingworth J, Kittler J. A survey of the Hough transform. Computer vision, graphics, and image processing, 1988, 44(1): 87-116.
[9] Docs.opencv.org, ‘Cascade Classification—OpenCV 2.4.12.0 documentation’, 2015. [Online]. Available: http://docs.opencv.org/2.4/modules/objdetect/doc/cascade_classification.html.
[10] Viola, P., Jones, M., & Snow, D. (2003). Detecting pedestrians using patterns of motion and appearance, 9th IEEE International Conference on Computer Vision (ICCV 2003), 14-17 Oct. 2003, Nice, France, 734-741.
[11] Teoh, S. S., & Bräunl, T. (2012). Symmetry-based monocular vehicle detection system. Machine Vision and Applications, 23:831-842.
[12] S. Tuohy et al., “Distance Determination for an Automobile Environment using Inverse Perspective Mapping in OpenCV,” Proc. 21st IET Irish Signals and Systems Conf. (ISSC 2010), June. 2010.

1-49. (canceled)

50: A method of assisting a full lane change process using at least five cameras provided on a vehicle, a computational device, and an augmented reality device, wherein the method comprises:
a) capturing images with the at least five cameras;
b) generating lane change information from the captured images; and
c) displaying the lane change information with the augmented reality device;
wherein the generating the lane change information further comprises:
b1) detecting lanes;
b2) detecting the positions and velocities of other vehicles surrounding the vehicle; and
b3) generating at least one lane change recommendation in as lane change recommendation unit.

51: The method according to claim 50, wherein a first camera is imaging an area in the driving direction of the vehicle, wherein a second camera and a third camera are imaging an area on a left side of the vehicle, and wherein a fourth camera and a fifth camera are imaging an area on a right side of the vehicle.

52: The method according to claim 51, wherein the first camera is capturing images from a position close to or at the front of the vehicle; and/or wherein the second camera and the third camera are capturing images from a position close to or at the left side mirror of the vehicle, and wherein the fourth camera and the fifth camera are capturing images from a position close to or at the right side mirror of the vehicle.

53: The method according to claim 50, wherein detecting the lanes further comprises:
locating areas of interest in the captured images according to the grey levels of different areas; and
detecting the edges of the road and/or the lane lines.

54: The method according to claim 53, wherein detecting the edges of the road and/or the lane lines utilizes a Sobel method.

55: The method according to claim 50, wherein detecting the positions and velocities of the other vehicles further comprises:
locating areas of interest in the captured images according to the grey levels of different areas; and
extracting the boundary of at least one vehicle.

56: The method according to claim 55, wherein the detecting the positions and velocities of the other vehicles utilizes a Haar-like feature detector.

57: The method according to claim 56, wherein the method further utilizes an AdaBoost algorithm.

58: The method according to claim 50, wherein the method utilizes two different techniques.

59: The method according to claim 58, wherein the two different techniques include a size filter technique and an aspect ratio filter technique.

60: The method according to claim 50, wherein the detecting the positions and velocities of the other vehicles further comprises:
transforming a coordinate system from one perspective to another using Inverse Perspective Mapping technology; and
using the time difference between two subsequent frames to calculate relative velocities between the other vehicles and the vehicle.

61: The method according to claim 50, wherein the displaying the lane change information further comprises:
converting the at least one lane change recommendation into graphical information; and
displaying the graphical information on the augmented reality device.

62: The method according to claim 61, wherein the graphical information is displayed with other information relevant to the driver.

63: The method according to claim 53, wherein the generating the at least one lane change recommendation further comprises:
making a lane change decision recommendation and/or selecting a target lane and/or selecting a target gap;
providing information on whether or not the target gap and a target speed are appropriate;
providing information on adjusting gaps between the vehicle and the other vehicles surrounding the vehicle;
providing information on synchronizing the speed of the vehicle to the target lane vehicle speed; and/or
providing information on a lane change execution.

64: The method according to claim 50, wherein prior to using the cameras, the method further comprises:
finding the camera focal length using the chessboard calibration; and/or
calibrating the cameras to estimate the real world length of a pixel.

65: A system for assisting a full lane change process with the help of an augmented reality device, the system comprising
at least five cameras provided on a vehicle and configured to capture images;
a computational device configured to generate lane change information from captured images; and
an augmented reality device configured to display the lane change information;
wherein to generate the lane change information the system is further configured to detect lanes and to detect the positions and velocities of other vehicles surrounding the vehicle, and further configured to generate at least one lane change recommendation in a lane change recommendation unit.

66: The system according to claim 65, wherein a first camera is configured to image an area in the driving direction of the vehicle, wherein a second camera and a third camera are configured to image an area on a left side of the vehicle, and wherein a fourth camera and a fifth camera are configured to image an area on a right side of the vehicle.

67: The system according to claim 66, wherein the first camera is positioned close to or at the front of the vehicle, wherein the second camera and the third camera are positioned close to or at the left side mirror of the vehicle, and wherein the fourth camera and the fifth camera are positioned close to or at the right side mirror of the vehicle.

68: The system according to claim 65, wherein to generate lane change information the system is further configured to detect lanes and to detect the position and velocities of other vehicles surrounding the vehicle.

69: The system according to claim 65, wherein to detect the lanes the system is further configured to locate areas of interest in the captured images according to the grey levels of different areas, and to detect the edges of the road and/or the lane lines.

70: The system according to claim 69, wherein the system is configured to detect the edges of the road and/or the lane lines using a Sobel method.

71: The system according to claim 65, wherein to detect the other vehicles the system is further configured to locate areas of interest in the captured images according to the grey levels of different areas, and to extract the boundary of at least one vehicle.

72: The system according to claim 71, wherein the system is further configured to use a Haar-like feature detector.

73: The system according to claim 72, wherein the system is further configured to use an AdaBoost algorithm.

74: The system according to claim 65, wherein the system is configured to use two different techniques.

75: The system according to claim 74, wherein the two different techniques include a size filter technique and an aspect ratio filter technique.

76: The system according to claim 65, wherein the system is configured to use Inverse Perspective Mapping technology to generate the positions and velocities of the other vehicles surrounding the vehicle by transforming a coordinate system from one perspective to another, and to use the time difference between two subsequent frames to calculate relative velocities between the other vehicles and the vehicle.

77: The system according to claim 65, wherein the system is configured to convert the at least one lane change recommendation into graphical information and to display the graphical information on the augmented reality device.

78: The system according to claim 77, wherein the system is configured to display the graphical information with other information relevant to the driver.

79: A vehicle with a system for assisting a full lane change process with help of an augmented reality device, wherein the system is configured to perform the following steps:
a) capturing images with the at least five cameras;
b) generating lane change information from the captured images; and
c) displaying the lane change information with the augmented reality device;
wherein the generating the lane change information further comprises:
b1) detecting lanes;
b2) detecting the positions and velocities of other vehicles surrounding the vehicle; and
b3) generating at least one lane change recommendation in as lane change recommendation unit.
